(19) United States
(12) Patent Application Publication
(10) Pub. No.: US 2023/0289842 A1
(43) Pub. Date: Sep. 14, 2023

(54) CONSUMER ANALYSIS ENGINES

(71) Applicant: Bond Brand Loyalty Inc., Mississauga (CA)

(72) Inventors: Sean Claessen, Toronto (CA); Francis Bernard Silva, Toronto (CA)

(73) Assignee: Bond Brand Loyalty Inc., Mississauga, ON (CA)

(21) Appl. No.: 18/006,227

(22) PCT Filed: Jul. 21, 2021
(86) PCT No.: PCT/IB2021/056606

§ 371 Date: Jan. 20, 2023

Related U.S. Application Data
(60) Provisional application No. 63/055,184, filed on Jul. 22, 2020.

(51) Int. Cl. G06Q 30/0211; G06F 21/62

(52) U.S. Cl. CPC G06Q 30/0211; G06F 21/6254

(57) ABSTRACT

An apparatus to analyze consumer behaviour is provided. The apparatus includes a communications interface to communicate with a first data source and a second data source. The first data source is to provide a first dataset and the second data source is to provide a second dataset. The apparatus further includes a collection engine to receive the first dataset and the second dataset via the communications interface. In addition, the apparatus includes a memory storage unit to store the first dataset and the second dataset. The apparatus also includes an aggregator to combine the first dataset and the second dataset to generate an aggregate dataset. The apparatus additionally includes an analysis engine to analyze the aggregate dataset to determine an effectiveness index of a promotional campaign.

### BACKGROUND

Data relating to consumer spending at a retailer or service provider based on a specific credit card has been collected. The data may be subsequently used to predict spending patterns of a consumer segment. It is known that modern consumers may have multiple credit cards and may use different credit cards based on various factors such as promotions, credit card features, or user preference.

### SUMMARY

In accordance with an aspect of the invention, an apparatus is provided. The apparatus includes a communications interface to communicate with a first data source and a second data source. The first data source is to provide a first dataset. The second data source is to provide a second dataset. The apparatus further includes a collection engine to request the first dataset and the second dataset. In addition, the apparatus includes a memory storage unit to store the first dataset and the second dataset. The apparatus also includes an aggregator to retrieve the first dataset and the second dataset from the memory storage unit. The aggregator is to combine the first dataset and the second dataset to generate an aggregate dataset. Furthermore, the apparatus includes an analysis engine to analyze the aggregate data to determine a effectiveness of a promotional campaign.

The datasets may include anonymized data. In addition, the first dataset may be from a retailer or service provider and the second dataset may be from a credit card provider.

The aggregator may remove duplicate data entries shared by the first dataset and the second dataset. The aggregator may also standardize the anonymization of the datasets. The aggregator may blend datasets between two or more of retailers or service providers, credit card providers and third party data sources, such as a fintech provider.

### BRIEF DESCRIPTION OF THE DRAWINGS

Reference will now be made, by way of example only, to the accompanying drawings in which:

FIG. 1 is a schematic representation of the components of an example apparatus to analyze consumer behavior;

FIG. 2 is a schematic representation of a system to provide access to the apparatus of FIG. 1 to analyze consumer behavior;

FIG. 3 is a schematic representation of the components of another example apparatus to analyze consumer behavior; and

FIG. 4 is a flowchart of an example of a method of analyzing consumer behavior.

### DETAILED DESCRIPTION

Various analysis tools used in marketing to provide estimates of consumer spending may collect present and future data from a single source, such as from a credit card company as it pertains to a store. Current analysis tools typically use limited datasets, such as a dataset limited to a retailer or service provider which only includes the spending patterns of their consumers using a particular credit card. It is to be appreciated by a person of skill with the benefit of this description that this may provide results that do not reflect the facts of the marketplace. For example, a consumer of the retailer may also buy similar goods and services from a second retailer, such as a competitor. As such, the predictive model may not process all spending on all cards of a consumer in the segment resulting in inaccurate predictions.

Credit card providers looking for consumer data may experience similar inaccuracies. For example, if a credit card provider were to provide a promotional offer, such as additional points to a loyalty program, the dataset limited to a retailer or service provider which only knows the spending patterns of their consumers using a particular credit card may not be able to provide an answer to the question of whether the retailer or service provider was successful as the consumer may have taken the same dollar spending in the aggregate and used it all on that credit card to the retailer. Accordingly, the promotion may not have resulted in increased sales. Instead, the promotion may have shifted the same aggregate spending to another credit card. While this may be a success for the credit card company due increased fee revenue, the retailer or service provider will not consider this to be a success.

In the examples provided herein, an apparatus is provided to collect data from multiple retailers and service providers and multiple credit card provider to provide a more accurate representation of spending by consumer segmentation. In other words, the apparatus may capture more data of consumer staple and consumer discretionary spending on prescriptions, household items etc. from multiple credit card providers to provide aggregate spend per industry and per retailer or service provider.

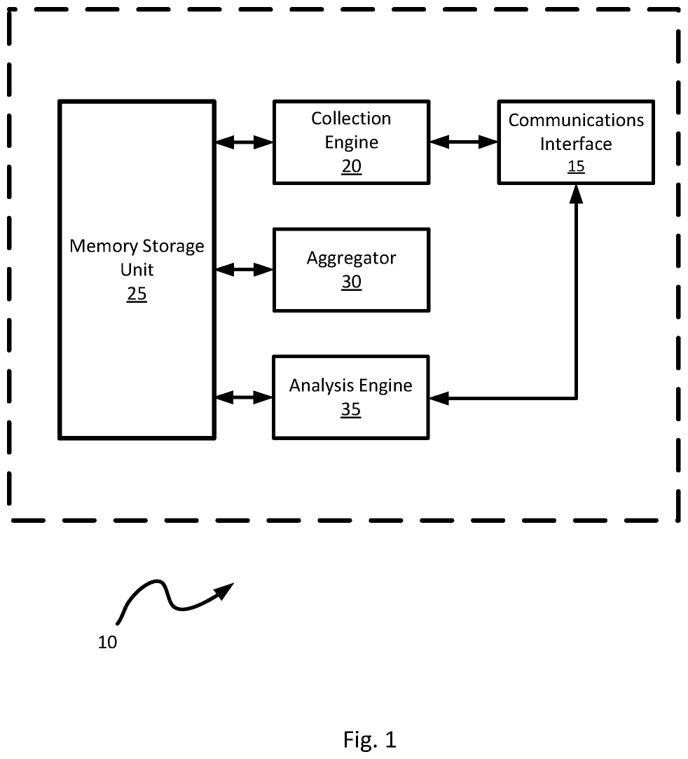

Referring to FIG. 1, an example of an apparatus to analyze consumer behavior is generally shown at 10. The apparatus 10 may include additional components, such as various interfaces to communicate with other devices, and further input and output devices to interact with a user or an administrator with access to control the apparatus 10. In the present example, the apparatus 10 includes a communications interface 15, a collection engine 20, a memory storage unit 25, an aggregator 30, and an analysis engine 35. Although the present example shows the collection engine 20, the aggregator 30, and the analysis engine 35 as separate components, in other examples, the collection engine 20, the aggregator 30, and the analysis engine 35 may be part of the same physical component such as a microprocessor configured to carry out multiple functions, or combined in a plurality of microprocessors.

The communications interface 15 is to communicate with external devices connected to a network. The external devices are not particularly limited and each device may be considered a data source for the apparatus 10. The exact number of external devices with which the communications interface 15 communicates is not limited. In addition, the external devices may be connected via different networks accessible by the communications interface 15. In the present example, the external devices may each be a data source that provides datasets of information. The manner by which each external device provides data to the communications interface 15 is not limited. For example, some external devices may transmit datasets to the apparatus 10 periodically. In other examples, external devices may send a dataset upon receiving a request from the apparatus 10. The dataset may include predetermined information, such as data associated with a time period, location, or other filter based on the content of the request.

The external devices from which the apparatus 10 receives data is not limited. For example, the external device may be a server managing consumer data from a retailer, a credit card provider, or a third party, such as a fintech intermediary. The consumer data is not particularly limited and may include data associated with a transaction carried out by the party associated with the external device. For example, an external device may be associated with a retailer to maintain a database containing data associated with each transaction carried out by the retailer. It is to be appreciated by a person of skill with the benefit of this description that in this specific example, the data stored by the retailer may include a transaction record with information such as the name of the consumer, a date and time of the transaction, the payment method, the loyalty program used by the consumer, the price of the purchased item, a description or identifier of the purchased item, the location of the transaction, the amount of time used to complete the transaction, and other details. It is to be understood that not all of this information may be included with each transaction and in some cases, further information may be collected. This information may then be used to generate a dataset of transactions from the retailer for transmitting to the apparatus 10.

In another example, the external device may be associated with a credit card provider to maintain a database containing data associated with each transaction carried out by a consumer. It is to be appreciated by a person of skill with the benefit of this description that in this specific example of credit card provider, the data stored may include a transaction record with information such as the name of the consumer, the name of the retailer or service provider, the classification of the retailer or service provider, a date and time of the transaction, the merchant fee associated with the transaction, the loyalty program used by the consumer, the price of the purchased item, the location of the transaction, and other details. It is to be understood that not all of this information may be included with each transaction and in some cases, further information may be collected. This information may then be used to generate a dataset of transactions carried out by a person associated with the credit card for transmitting to the apparatus 10.

Although the datasets from various external device is different since each external device manages different data, it is to be appreciated with the benefit of this description that some data records may include information that overlaps. Continuing with the above example where one external device is associated with a retailer and another external device is associated with a credit card provider, data associated with a purchase of an item from the retailer using the credit card of the credit card provider will generate a data record in each of the external devices. Since these data records are about the same transaction, they should not be double counted when the datasets from the retailer and the credit card provider are aggregated as discussed in further detail below.

The manner by which the communications interface 15 transmits and receives data is not particularly limited. In the present example, the communications interface 15 may communicate with the external device over a network, which may be a public network shared with a large number of connected devices, such as a WiFi network or cellular network. In other examples, the communications interface 15 may receive data from an external device via a private network, such as an intranet or a wired connection with other devices. As another example, the communications interface 15 may connect to another proximate device via a wired connection, a Bluetooth connection, radio signals, or infrared signals.

The collection engine 20 is to obtain the datasets received at the apparatus 10 via the communications interface 15. In particular, the collection engine 20 is to receive the datasets from the external devices. In some examples, the collection engine 20 may manage the different datasets for the aggregator 30. For example, the collection engine 20 may be to generate and send a specific request to an external device or data source to provide a dataset with transaction data, such as sales data. As an example, the collection engine 20 may request a dataset from a retailer or service provider and another dataset from a credit card provider to analyze consumer trends at the retailer or service provider. It is to be appreciated by a person of skill with the benefit of this description that the collection engine 20 may request datasets from additional external devices associated with other data sources, such as additional credit card providers, banks, or third party payment system. The datasets are not particularly limited and may include information about each transaction logged by the external device. In the case of a dataset from a retailer, the dataset may include information such as a transaction record with a name or other identifying details of the consumer, a date and time of the transaction, the payment method, the loyalty program used by the consumer, the price of the purchased item, a description or identifier of the purchased item, the location of the transaction, the amount of time used to complete the transaction, and other details. In the case of a dataset from a credit card provider, the dataset may include information such as a transaction record with information such as the name of the consumer, the name of the retailer or service provider, the classification of the retailer or service provider, a date and time of the transaction, the merchant fee associated with the transaction, the loyalty program used by the consumer, the price of the purchased item, the location of the transaction, and other details.

Although the datasets may appear to include similar information, the level of detail for each type of information may vary between different data sources. For example, a retailer may store less information about the consumer, such as age, income, race, address, etc., unless the information is specifically collected. As another example, the credit card provider may store less information about the transaction details, such as the details regarding the item or service that was purchased. In the case of a third party data source, the dataset received may include data from a retailer or service provider or a credit card provider that has been anonymized such that personal identity information is removed from the dataset. In particular, the dataset may include categories of consumer segments into which each transaction may be classified.

The memory storage unit 25 is to store datasets received from the external data sources via the communications interface 15. The manner by which the datasets are stored is not particularly limited. For example, the memory storage unit 25 may be to maintain a database where each dataset may be stored as a record in the database that includes the dataset and data source information. In particular, each record may identify the data source and include the type of data source.

The memory storage unit 25 may be also used to store addition data to be used by the apparatus 10. For example, the memory storage unit 25 may store various datasets from other external devices or reference data related to each retailer and/or consumer. For example, reference data may include details related to offers offered by a party to the transaction, such as a sale, loyalty point awards, or cashback amounts.

It is to be appreciated that the memory storage unit 25 may be a physical computer readable medium used to maintain multiple databases, or may include multiple mediums that may be distributed across one or more external servers, such as in a central server or a cloud server. In some examples, the memory storage unit 25 may be preloaded with data, such as instructions, to operate components of the apparatus 10. In other examples, the instructions may be loaded via the communications interface 15 or by directly transferring the instructions from a portable memory storage device connected to the apparatus 10, such as a memory flash drive.

In the present example, the memory storage unit 25 is not particularly limited and may include a non-transitory machine-readable storage medium that may be, for example, an electronic, magnetic, optical, or other physical storage device. In the present example, the memory storage unit 25 is a persistent memory that may also store an operating system that is executable by a processor to provide general functionality to the apparatus 10. The memory storage unit 25 may additionally store instructions used by a processor to operate at the driver level and to communicate with other components and peripheral devices of the apparatus 10. Furthermore, the operating system may provide functionality to additional applications operating on the apparatus 10 in addition to an application manipulating datasets.

The aggregator 30 is to combine the datasets received by the apparatus 10 to generate an aggregate dataset. The manner by which the aggregator 30 combines the datasets is not particularly limited and may include retrieving a plurality of datasets from the memory storage unit 25 to process. The aggregator 30 may simply add the data records from different datasets together to form the aggregate dataset. In some examples, the aggregator 30 may identify corresponding fields associated with a single transaction in different datasets. The aggregator 30 may then merge the information from the original datasets to populate corresponding fields in a single data record in the aggregated dataset. For example, if the dataset from the retailer or service provider includes a data record field for storing the name of a consumer and the dataset from the credit card provider includes a data record field for storing the name of an account holder, the aggregator 30 may store information from the two fields in the name data record field of the aggregate dataset. In some examples, the aggregator 30 may also normalize the data in each field to account for formatting differences. For example, a field used to store a transaction date from the retailer or service provider may use a different format from the field used to store a transaction date from the credit card provider. Another example of fields to be normalized may be a name field where one dataset stores the data with the surname first and the other dataset stores the data with the given name(s) first.

In further examples, the aggregator 30 may be used to identify data records in the aggregate dataset associated with a single transaction or event. If the aggregate dataset includes multiple records from the source datasets about a single transaction or event, the transaction or event may be double counted by the analysis engine 35. It is to be appreciated by a person of skill with the benefit of this description that double counting data records may affect the results of the analysis engine 35. In the present example, the aggregator 30 may remove or merge duplicate data records then the data records are suspected of being duplicate entries such that the same transaction is not to be double counted. Continuing with the present example where the source of one datasets is from a retailer and a second dataset is from a credit card provider associated with the retailer, it will be appreciated by a person of skill with the benefit of this description that there may exist some overlap of data records associated with transactions where the credit card provider and the retailer may record the same transaction by a consumer using the credit card associated with the credit card provider at the specific retailer to make a purchase. The data records that do not overlap will not be merged, such as when the consumer makes a purchase at a different retailer from the retailer providing the dataset or if the consumer uses a different form of payment not associated with the credit card provider at the retailer.

In examples where the data collected by the collection engine 20 is anonymized, the aggregator 30 may be used to blend anonymized datasets from different external devices. Since each external device may store data in data records using different categories or different methods, it is to be appreciated that the aggregator 30 may be configured to identify and remove duplicate anonymized data entries in these examples.

Therefore, it is to be appreciated by a person of skill in the art with the benefit of this description that the aggregator 30 is to combine datasets from multiple sources to generate the aggregate dataset. The aggregate dataset is not particularly limited and may include various formats that may be dependent on the application criteria and vary from one implementation to another. The aggregate dataset is to provide the analysis engine 35 with a uniform dataset from which various predictions, evaluations and consumer information may be extracted.

In the present example, the analysis engine 35 is to analyze the aggregate dataset to provide marketing data with which a user may consider to formulate additional promotional campaigns. For example, the analysis engine 35 may be used to determine the effectiveness of a promotional campaign by determining an effectiveness index. The effectiveness index is not particularly limited and variations are contemplated. For example, the effectiveness index may be used to measure an increase in revenue based on a promotional campaign. The effectiveness index may take into account other factors as well such as the costs of the promotional campaign as wells as the length of time over which data is collected. In a specific example, the effectiveness index may be a percentage of increase in revenue or profit above a baseline determined prior to beginning the promotional campaign. It is to be appreciated by a person of skill with the benefit of this description that additional indices may also be generated to provide additional insight into the aggregate dataset.

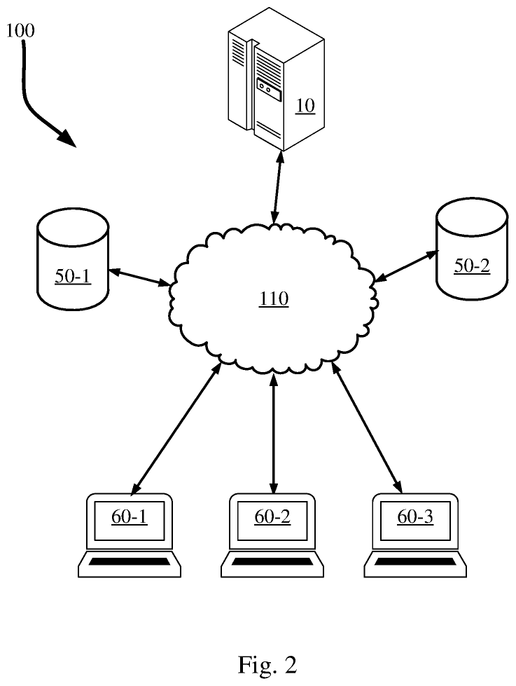

Referring to FIG. 2, a schematic representation of a computer network system is shown generally at 100. It is to be understood that the system 100 is purely exemplary and it will be apparent to those skilled in the art that a variety of computer network systems are contemplated. The system 100 includes the apparatus 10 to analyze consumer behavior, a plurality of external devices 50-1 and 50-2 (generically, these external devices are referred to herein as “external device 50” and collectively they are referred to as “external devices 50”), and a plurality of content requesters 60-1, 60-2, 60-3 (generically, these content requesters are referred to herein as “content requesters 60” and collectively they are referred to as “content requesters 60”) connected by a network 110. The network 110 is not particularly limited and may include any type of network such as the Internet, an intranet or a local area network, a mobile network, or a combination of any of these types of networks. In some examples, the network 110 may also include a peer to peer network.

In the present example, the external devices 50 may be any type of computing device used to communicate with the apparatus 10 over the network 110 for providing datasets having data records of transactions from a party involved in the transaction. In the present example, the external device 50-1 may be a server of a retailer or service provider configured to store transaction data collected by the retailer or service provider. The data may include a wide variety information depending on the data collection policies of the retailer or service provider. For example, the dataset generated at the external device 50-1 may include information such as a transaction record with a name or other identifying details of the consumer, a date and time of the transaction, the payment method, the loyalty program used by the consumer, the price of the purchased item, a description or identifier of the purchased item, the location of the transaction, the amount of time used to complete the transaction, and other details. In present example, the external device 50-2 may be a server of a credit card provider configured to store transaction data collected by the credit card provider. The data may include a wide variety information depending on the data collection policies of the credit card provider. For example, the dataset generated at the external device 50-2 may include information such as a transaction record with information such as the name of the consumer, the name of the retailer, the classification of the retailer, a date and time of the transaction, the merchant fee associated with the transaction, the loyalty program used by the consumer, the price of the purchased item, the location of the transaction, and other details.

The external devices 50 are not limited and the datasets that they provide may also vary. In addition, although only two external devices 50 are shown in this example, it is to be appreciated by a person of skill with the benefit of this description that additional external devices 50 may be added to the system 100. Furthermore, the apparatus 10 may be scaled to accommodate any number of external devices 50 provided that the apparatus 10 has sufficient computational resources to process the dataset. In other examples, the external devices 50 may provide datasets from banks, loyalty programs, payment providers, advertisers, and regulators.

The content requesters 60 may also be any type of computing device used to communicate with the apparatus 10 over the network 110 for receiving the results of an analysis, such as an effectiveness index. The content requesters 60 may use the effectiveness index to subsequently evaluate the success of a marketing campaign that has been completed or currently in progress, observe consumer behaviors, and/or develop additional marketing campaigns or shift the strategy of an ongoing campaign. In some examples, the content requester 60 may request more a detailed analysis and additional indices or the aggregate dataset to carry out additional analysis and processing.

As an example, the content requester 60-1 may be a separate device to determine the amount of shifting behavior on the part of the consumers in response to a promotional campaign. As a specific example, if a retailer or service provider associated with the external device 50-1 offers a special promotion with a credit card provider associated with the external device 50-2 where a consumer receives a discount by using the credit card associated with the credit card provider to make the purchase, the retailer or service provider may want to determine the amount of consumer shifting behavior that occurs. In particular, if consumers were to change their method of payment from something else, such as cash or another credit card, the retailer or service provider may not see any significant increase sales and consider the promotional campaign a failure. However, the credit card provider may not be concerned about the shifting behavior as more purchases using the credit card may be beneficial to the credit card provider. Accordingly, the value of the effectiveness index generated by the analysis engine may have different meanings for different parties and help them decide on whether to continue with or renew the promotional campaign based on the processing of information by the content requester 60-1.

A specific implementation of the content requester 60-1 is a device with SHARESHIFTER functionality to provide an advantage in negotiating retailer funded reward offer promotional campaigns involving a specific credit card. In particular, by collecting data from multiple sources, the apparatus 10 may be used to provide evidence to the content requester 60-1 of increased value to a retailer, such as increased overall sales at the retailer instead of merely shifting a share of transactions from a credit card or cash to another credit card due to the promotional campaign.

In the present example, the content requester 60-2 may be a separate device to determine the value of a consumer. In particular, the content requester 60-2 may be a device operating as an ACQUISITION OPTIMIZER module to extract information from the aggregate dataset to provide a projected consumer lifetime value of a potential consumer. By viewing data from more sources such as spending habits, a more comprehensive view of the consumer's spending habits may be inferred such that a more precise estimate of the consumer lifetime value may be generated. With the knowledge of the consumer lifetime value, a proportional amount of resources may be used in a promotional campaign to onboard the consumer.

In particular, the content requester 60-2 may receive the aggregate dataset as well as at least one effectiveness index. The content requester 60-2 may then review the spending habits of a specific consumer. The spending habits are then compared with various metrics, such as the effectiveness index to determine the cost to onboard the consumer. If the expected value of a consumer is known, a determination may be easily made as to whether the consumer is worth onboarding.

The content requester 60-3 may be a separate device to determine the value of a new consumer based on past performance. In particular, the content requester 60-3 may be a device operating as a MEMBER ACCELERATOR module to provide information to tailor campaigns that look at the past purchasing history of a consumer. In particular, the apparatus 10 provides the information to determine a snapshot of a consumer's spending history across multiple payment forms as well as retailers and/or service providers. Accordingly, the content requester 60-3 may benefit from having more retailers and/or service providers connected to the apparatus 10 in the system 100. In such an example, a retailer or service provider may use information on a consumer's spending habits across multiple retailers and service providers to determine and provide credit or other rewards in a proportional amount to encourage the consumer to shop at one retailer or service provider and discourage the consumer from shopping at a competitor retailer or service provider. For example, if a consumer has a large spending history one retailer or service provider, a competing retailer or service provider may use this information to provide larger incentives to draw that specific consumer to the competing retailer or service provider.

It is to be appreciated by a person of skill with the benefit of this description that although the content requesters 60-1, 60-2, 60-3 are shown as separate devices in this example, other examples may combine one or more of the content requesters 60 into a single device. Furthermore, in some examples, the content requesters 60 may be modules running within the apparatus 10 as well.

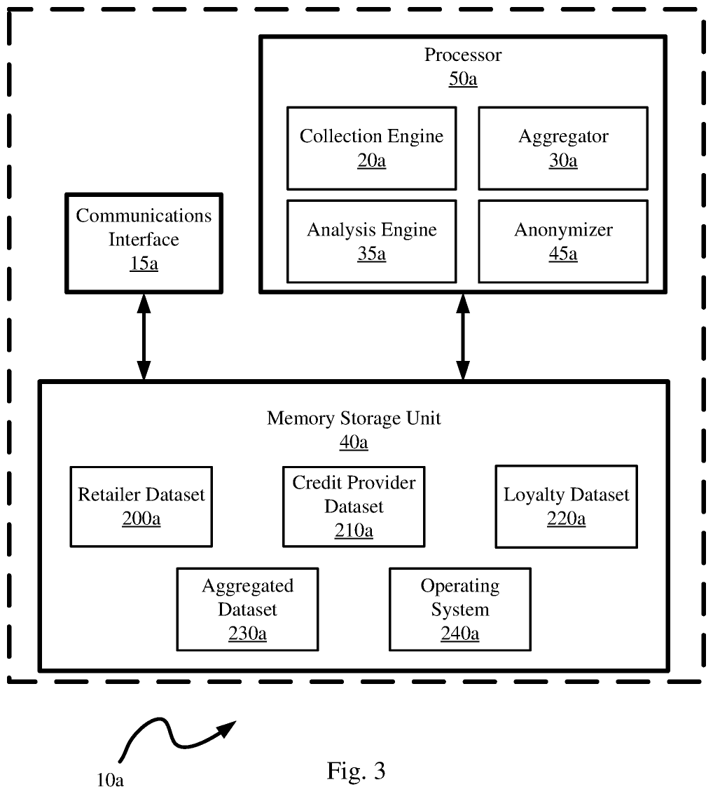

Referring to FIG. 3, another schematic representation of an apparatus 10a to analyze consumer behavior is generally shown. Like components of the apparatus 10a bear like reference to their counterparts in the apparatus 10, except followed by the suffix “a”. In the present example, the apparatus 10a includes a communications interface 15a, a memory storage unit 25a, and a processor 40a. In the present example, the processor 40a operates a collection engine 20a, an aggregator 30a, and an analysis engine 35, and an anonymizer 45a.

In the present example, the memory storage unit 25a maintains databases to store various data used by the apparatus 10a. For example, the memory storage unit 25a may include a database 200a to store datasets received from multiple retailers and/or service providers, a database 210a to store datasets received from a credit card provider or financial institution, a database 220a to store datasets received from a loyalty provided, and a database 230a to store the aggregate dataset generated by the aggregator 30a. In addition, the memory storage unit 25a may include an operating system 240a that is executable by the processor 40a to provide general functionality to the apparatus 10a. Furthermore, the memory storage unit 25a may be encoded with codes to direct the processor 40a to carry out specific steps to perform a method described in more detail below. The memory storage unit 25a may also store instructions to carry out operations at the driver level as well as other hardware drivers to communicate with other components and peripheral devices of the apparatus 10a, such as various user interfaces to receive input or provide output.

In the present example, the processor 40a further operates an anonymizer 45a to anonymize a dataset that may include personal identity information. The anonymizer 45a may remove personal identity information or other confidential information from a dataset, but maintains all other information, such as a date and time of the transaction, the payment method, the loyalty program used by the consumer, the price of the purchased item, a description or identifier of the purchased item, the location of the transaction, the amount of time used to complete the transaction, all of which do not provide any information that may identify a particular consumer. For example, personal identity information may include a name, an address, a phone number, bank account number, and/or credit card information.

In some examples, the anonymizer 45a may use an indexing key to replace the personal identity information with an index value or another anonymous identifier, such as a generic identifier, or a sequential serial number. Therefore, the anonymized dataset generated by the anonymizer 45a may be de-anonymized with the appropriate decryption key or lookup table. By having the ability to restore the original dataset from the anonymized data, an audit may be subsequently performed if requested to verify the dataset.

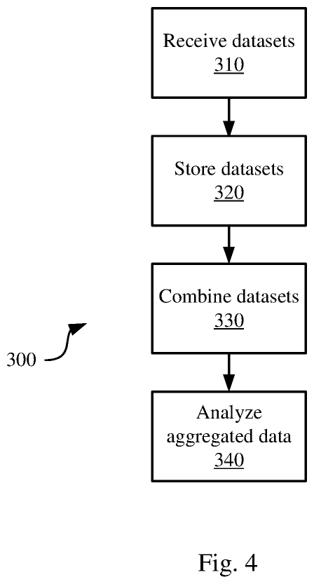

Referring to FIG. 4, a flowchart of an example method of generating and assigning a mechanical weight index based on a single two-dimensional image for mesh skinning is generally shown at 300. In order to assist in the explanation of method 300, it will be assumed that method 300 may be performed by the apparatus 10. Indeed, the method 300 may be one way in which the apparatus 10 may be configured. Furthermore, the following discussion of method 300 may lead to a further understanding of the apparatus 10 and it components. In addition, the method 300 may not be performed in the exact sequence as shown, and various blocks may be performed in parallel rather than in sequence, or in a different sequence altogether.

Beginning at block 310, the apparatus 10 receives datasets from a plurality of external devices via the communications interface 15. In the present example, the apparatus 10 may be connected to two or more external devices that provide datasets. The datasets are not particularly limited and each dataset may include information such as transaction records that contain the name of the consumer, the name of the retailer or service provider, the classification of the retailer or service provider, a date and time of the transaction, and other details associated with transactions. Once received at the apparatus 10, the datasets are to be stored in the memory storage unit 25 at block 320.

Block 330 involves combining the datasets received at block 310 with the aggregator 30 to generate aggregate data. The manner by which the datasets are combined is not particularly limited and may include adding the data records from different datasets together to form the aggregate dataset. In some examples, data records associated with a single transaction may be identified and corresponding fields in data records of different datasets may be merged to populate corresponding fields in the aggregate dataset. At block 340, the aggregate dataset is analyzed to provide marketing data with which a user may consider when deciding on additional promotional campaigns. The marketing data provided is not limited and may include an effectiveness index to track a metric, such as a measure of the increase in revenue based on a promotional campaign.

Various advantages will not become apparent to a person of skill in the art. In particular, the apparatus 10 may be used to collect more data from multiple data sources. By aggregating this data and analyzing the aggregated data accordingly, the apparatus 10 may be used to manipulate and extract information that was not previously possible to be used to generate more targeted and effective promotional campaigns.

It should be recognized that features and aspects of the various examples provided above may be combined into further examples that also fall within the scope of the present disclosure.

1. An apparatus comprising:
a communications interface to communicate with a first data source and a second data source, wherein the first data source is to provide a first dataset, and wherein the second data source is to provide a second dataset;
a collection engine to receive the first dataset and the second dataset via the communications interface;
a memory storage unit to store the first dataset and the second dataset;
an aggregator to combine the first dataset and the second dataset to generate an aggregate dataset; and
an analysis engine to analyze the aggregate dataset to determine an effectiveness index of a promotional campaign.

2. The apparatus of claim 1, wherein the first dataset is anonymized to remove first personal identity information.

3. The apparatus of claim 2, wherein the second dataset is anonymized to remove second personal identity information.

4. The apparatus of claim 3, further comprising an anonymizer to anonymize one of the first dataset or the second dataset.

5. The apparatus of claim 1, wherein the first data source is a retailer.

6. The apparatus of claim 5, wherein the second data source is a credit card provider.

7. The apparatus of claim 6, wherein the aggregator identifies records from the aggregate dataset associated with a transaction to reduce double counting of the transaction.

8. A method comprising:
receiving a first dataset from a first data source via a communications interface;
receiving a second dataset from a second data source via the communications interface;
storing the first dataset and the second dataset in a memory storage unit;
combining the first dataset and the second dataset to generate an aggregate dataset; and
analyzing the aggregate dataset to determine an effectiveness index of a promotional campaign.

9. The method of claim 8, further comprising anonymizing the first dataset to remove first personal identity information.

10. The method of claim 9, further comprising anonymizing the second dataset to remove second personal identity information.

11. The method of claim 8, further comprising sending a first request for the first dataset and sending a second request for the second dataset.

12. The method of claim 11, wherein sending the first request comprises sending the first request to a retailer.

13. The method of claim 12, wherein sending the second request comprises sending the first request to a credit card provider.

14. The method of claim 8, further comprising identifying records from the aggregate dataset associated with a transaction to reduce double counting of the transaction.

15. A non-transitory computer readable medium encoded with codes, wherein the codes are to direct a processor to:
receive a first dataset from a first data source via a communications interface;
receive a second dataset from a second data source via the communications interface;
store the first dataset and the second dataset in a memory storage unit;
combine the first dataset and the second dataset to generate an aggregate dataset; and
analyze the aggregate dataset to determine an effectiveness index of a promotional campaign.

16. The non-transitory computer readable medium of claim 15, wherein the codes are to direct the processor to anonymize the first dataset and the second dataset to remove personal identity information.

17. The non-transitory computer readable medium of claim 15, wherein the codes are to direct the processor to send a first request for the first dataset and to send a second request for the second dataset.

18. The non-transitory computer readable medium of claim 17, wherein the codes are to direct the processor to send the first request to a retailer.

19. The non-transitory computer readable medium of claim 18, wherein the codes are to direct the processor to send the first request to a credit card provider.

20. The non-transitory computer readable medium of claim 15, wherein the codes are to direct the processor to identifying records from the aggregate dataset associated with a transaction to reduce double counting of the transaction.
